(19) United States
(12) Patent Application Publication
(10) Pub. No.: US 2019/0370757 A1
(43) Pub. Date: Dec. 5, 2019

(54) METHOD, SERVER FOR MAINTENANCE SITES MANAGEMENT, AND COMPUTER READABLE STORAGE MEDIUM

(71) Applicant: Launch Tech Co., Ltd., Shenzhen (CN)

(72) Inventors: Jun LIU, Shenzhen (CN); Xueying MAI, Shenzhen (CN)

(21) Appl. No.: 16/167,948

(22) Filed: Oct. 23, 2018

(30) Foreign Application Priority Data
May 30, 2018 (CN) PCT/CN2018/088952

(51) Int. Cl. G06Q 10/00; G06Q 10/02; G06Q 20/28; G06Q 20/40

(52) U.S. Cl. CPC G06Q 10/20; G06Q 20/401; G06Q 20/28; G06Q 10/02

(57) ABSTRACT

A method, a server for maintenance sites management, and a computer readable storage medium, the method comprises: receiving reservation information sent by client; wherein the reservation information comprises at least a target maintenance site and a target usage duration; receiving check-in information during the target usage duration; providing usage permission of the target maintenance site to the client according to the check-in information. The method for maintenance sites management provided by the present disclosure, users only need to complete the check-in operation on the client during the target usage duration, the target maintenance site can be used during the target usage duration. The maintenance sites do not need to be registered by a special person, which reduces the labor cost and improves the usage efficiency of the maintenance sites, further realizing the sharing of the maintenance sites.

### CROSS-REFERENCE TO RELATED APPLICATIONS

This application is a national phase application under 35 U.S.C. § 371 of International Patent Application No. PCT/CN2018/088952 filed May 30, 2018, the entire contents of which are incorporated herein by reference for all purposes.

### TECHNICAL FIELD

The present disclosure relates to a technical field of maintenance service, and more particularly, to a method, a server for maintenance sites management and a computer readable storage medium.

### TECHNICAL BACKGROUND

In the prior art, users may reserve a maintenance site through a telephone or an application in the mobile phone, and a specially-assigned person is needed in the maintenance site to register and deal with the reservation information and the use of equipments, resulting in lots of human resources being consumed, thus the cost is relatively high. Meanwhile, the efficiency of manual register is low, resulting in relatively low service efficiency of the maintenance site.

Therefore, it is a problem to be solved for persons skilled in the art how to improve the service efficiency of the maintenance site.

### SUMMARY

The present disclosure aims at providing a method, a server for maintenance sites management and a computer readable storage medium, such that to improve the service efficiency of the maintenance site.

In order to achieve the above purpose, a first aspect of the present disclosure provides a method for maintenance sites management comprising:
receiving reservation information sent by client; wherein the reservation information comprises at least a target maintenance site and a target usage duration;
receiving check-in information during the target usage duration;
providing usage permission of the target maintenance site to the client according to the check-in information.

With reference to the first aspect of the present disclosure, and in a first possible implementation of the first aspect of the present disclosure, before receiving reservation information sent by client, the method further comprises:
receiving reservation request submitted by the client;
sending information on at least one maintenance site to the client according to the reservation request, such that a user confirms the reservation information according to the information on at least one maintenance site.

With reference to the first aspect of the present disclosure, and in a second possible implementation of the first aspect of the present disclosure, after receiving reservation information sent by client, the method further comprises:
determining usage deposit of the target maintenance site according to the reservation information;
initiating a payment transaction request of the usage deposit to the client, to enable the client to complete a deposit payment transaction;
assigning a reservation usage qualification of the target maintenance site to the client, after the client completes the deposit payment transaction.

With reference to the first aspect of the present disclosure, and in a third possible implementation of the first aspect of the present disclosure, the reservation information further comprises a client identity identifier or an equipment identifier for maintenance;
that providing usage permission of the target maintenance site to the client according to the check-in information specifically comprises:
determining whether the client identity identifier in the check-in information is consistent with that in the reservation information, and/or
determining whether the equipment identifier in the check-in information is consistent with the equipment identifier for maintenance in the reservation information;
if consistent, providing usage permission of the target maintenance site to the client.

With references to the first aspect of the present disclosure, the first possible implementation of the first aspect of the present disclosure, the second possible implementation of the first aspect of the present disclosure and the third possible implementation of the first aspect of the present disclosure, in a fourth possible implementation of the first aspect of the present disclosure, the method further comprises:
receiving end-of-use request submitted by the client, and obtaining current status information of all equipments at the target maintenance site;
determining whether operating status of all the equipments is normal according to the current status information;
sending a checkout reminder information to the client according to judgment result;
turning off the usage permission of the target maintenance site to the client, after receiving a checkout information from the client.

With reference to the fourth possible implementation of the first aspect of the present disclosure, in a fifth realizable implementation of the first aspect of the present disclosure, before sending the checkout reminder information to the client, the method further comprises:
generating a maintenance service list and a charge list according to user's usage process;
generating an additional fee list based on the judgment result;
initiating a payment transaction request, based on the service list, the charge list and the additional fee list, to the client, such that the client completes the payment transaction;
sending the checkout reminder information to the client, after the client has completed the payment transaction.

In order to achieve the above purpose, a second aspect of the present disclosure provides a server for maintenance sites management comprising:
a memory storing executable computer programs;
a processor coupled with the memory;
when used for executing the computer programs the processor implements steps of: receiving reservation information sent by client;
wherein the reservation information comprises at least a target maintenance site and a target usage duration; receiving check-in information during the target usage duration; providing usage permission of the target maintenance site to the client according to the check-in information.

With reference to the second aspect of the present disclosure, in a first possible implementation of the second aspect of the present disclosure, when executing the computer programs stored in the memory the processor implements steps of: receiving a reservation request submitted by the client; sending information on at least one maintenance site to the client according to the reservation request such that a user confirms the reservation information according to the information on the at least one maintenance site.

With reference to the second aspect of the present disclosure, in a second possible implementation of the second aspect of the present disclosure, when executing the computer programs stored in the memory the processor implements steps of:
determining usage deposit of the target maintenance site according to the reservation information;
initiating a payment transaction request of the usage deposit to the client, to enable the client to complete a deposit payment transaction;
assigning a reservation usage qualification of the target maintenance site to the client after the client completes the deposit payment transaction.

With reference to the second aspect of the present disclosure, in a third possible implementation of the second aspect of the present disclosure, when executing the computer programs stored in the memory the processor implements steps of: determining whether the client identity identifier in the check-in information is consistent with that in the reservation information, and/or determining whether the equipment identifier in the check-in information is consistent with the equipment identifier for maintenance in the reservation information; if consistent, providing usage permission of the target maintenance site to the client.

With references to the second aspect of the present disclosure, the first possible implementation of the second aspect of the present disclosure, the second possible implementation of the second aspect of the present disclosure and the third possible implementation of the second aspect of the present disclosure, in a fourth possible implementation of the second aspect of the present disclosure, when executing the computer programs stored in the memory the processor implements steps of: receiving end-of-use request submitted by the client, and obtaining current status information of all equipments at the target maintenance site; determining whether operating status of all the equipments are normal according to the current status information; sending a checkout reminder information to the client according to judgment result; turning off the usage permission of the target maintenance site to the client after receiving a checkout information from the client.

With reference to the fourth possible implementation of the second aspect of the present disclosure, in a fifth possible implementation of the second aspect of the present disclosure, when executing the computer programs stored in the memory the processor implements steps of: generating a maintenance service list and a charge list according to user's usage process; generating an additional fee list based on the judgment result;
initiating a payment transaction request, based on the service list, the charge list and the additional fee list, to the client, such that the client completes the payment transaction; sending the checkout reminder information to the client, after the client has completed the payment transaction.

In order to achieve the above purpose, a third aspect of the present disclosure provides a computer readable storage medium storing computer programs, and when executed by a processor the computer programs implement steps of the first aspect and any one of the possible implementations in the first aspect.

It can be seen through the above solutions that, the present disclosure provides a method for maintenance sites management comprising: receiving reservation information sent by client; wherein the reservation information comprises at least a target maintenance site and a target usage duration; receiving check-in information during the target usage duration; providing usage permission of the target maintenance site to the client according to the check-in information.

The method for maintenance sites management provided by the present disclosure, obtains the reservation information of the users through the client, and the reservation information comprises at least the target maintenance site and the target usage duration. The users only need to complete the check-in operation on the client during the target usage duration, and the target maintenance site can be used during the target usage duration. The maintenance sites do not need to be registered by a special person, which reduces the labor cost and improves the usage efficiency of the maintenance sites, further realizing the sharing of the maintenance sites. The present disclosure further discloses a server for maintenance sites management and a computer readable storage medium, which can also achieve the above technical effects.

### BRIEF DESCRIPTION OF THE DRAWINGS

In order to illustrate the embodiments of the present disclosure or the technical solutions in the prior art more clearly, the drawings to be used in the description of the embodiments or the prior art will be briefly described below.

FIG. 1 is a flow chart of one method for maintenance sites management disclosed by an embodiment of the present disclosure;

FIG. 2 is a flow chart of another method for maintenance sites management disclosed by an embodiment of the present disclosure;

FIG. 3 is a structural schematic view of one server for maintenance sites management disclosed by an embodiment of the present disclosure;

FIG. 4 is a structural schematic view of another server for maintenance sites management disclosed by an embodiment of the present disclosure.

### DETAILED DESCRIPTION

With reference to the figures in embodiments of the present disclosure, the technical solutions in embodiments of the present disclosure will be described clearly and completely below.

The method for maintenance sites management provided by the present disclosure, is applicable to the reservation of maintenance sites for vehicles or electrical equipments. The users may make reservation request to the server through the client, and select the target maintenance site and the target usage duration according to the sites information returned from the server. The users only need to complete the check-in operation during the target usage duration, then obtain the usage permission for the target maintenance site. The maintenance sites do not need to be registered by a special person, which reduces the labor cost and improves the usage efficiency of the maintenance sites, further realizing the sharing of the maintenance sites.

An embodiment of the present disclosure discloses a method for maintenance sites management, which improves the usage efficiency of the maintenance sites.

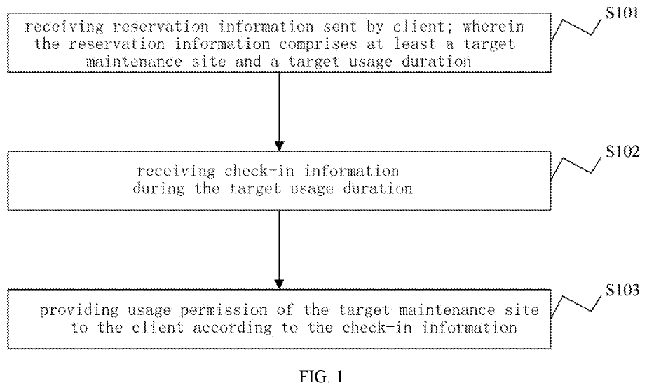

Referring to FIG. 1, a flow chart of a method for maintenance sites management, disclosed by an embodiment of the present disclosure shown as FIG. 1, comprising:

S101: receiving reservation information sent by client; wherein the reservation information comprises at least a target maintenance site and a target usage duration.

In detailed implementation, the server collects the reservation information of the user through the client, and the reservation information herein comprises at least target maintenance site and target usage duration, of course may further comprises information of reservation person and equipments to be maintain, which are all in the protection scope of the present embodiment. The user needs to fill in the above reservation information in the client, as a preferred implementation, the user also needs to agree with the usage protocol for the target maintenance site, and the client generates the reservation information based on the above information and sends it to the server. As a preferred implementation, in order to avoid arbitrary changes in the usage protocol of each maintenance site, the usage protocol corresponding to said maintenance site may be uploaded to a block chain for storage, which can ensure that the usage protocol is safe and is not able to tampered taking advantage of the decentralized and non-tampered features of the block chain.

It should be noted that, steps of receiving the reservation request submitted by the client may be comprised before step 101. Specifically, the user sends reservation request to the server through the client, to obtain information on at least one maintenance site, of course the server may send information with all maintenance sites to the user, such that the user makes selection according to the maintenance sites information obtained.

As a preferred implementation, the above reservation request may comprise the user's current location information and the failure information of the equipments to be repaired. The server selects a satisfied candidate maintenance sites based on the failure information, and sends the site information of the candidate maintenance sites to the client, herein the site information includes at least available time period of the candidate maintenance sites, and may also include charge standard of the candidate maintenance sites.

Surely, the site information of the candidate maintenance sites may be ranked depending on a predefined rules before sending, for example, ranking depending on the distances between the candidate maintenance sites and the current location or the like.

As a more preferred implementation, the user may limit conditions of the candidate maintenance sites during reservation request, for example, the user may select a charging range of the maintenance sites, a distance range from the current location or the like, the client will package these limited conditions in the reservation request and send it to the server, such that the server selects the candidate maintenance sites meeting the limited conditions.

It should be appreciated that, to ensure the user's civilized use of the maintenance sites and the normal operation of each maintenance site, as a preferred embodiment, a means of charging a deposit may be adopted.

Specifically, after the server has received the reservation information sent by the client, determining the usage deposit of the target maintenance site and initiating the payment transaction request of the usage deposit to the client, and after the deposit payment transaction has been finished in the client, assigning the reservation usage qualification of the target maintenance site to said client. The user may use common payment means, such as network bank payment, third-party payment etc., to complete the deposit payment transaction in the client, and it is not limited specifically herein. As a preferred implementation, the above deposit payment transaction may be uploaded to the block chain for storage, that is to say, the server uploads the deposit payment transaction to the block chain through a block chain node, so that other nodes of the block chain synchronize the deposit payment transaction, and the security of the deposit payment transaction is ensured taking advantage of the decentralized and non-tamperable features of the block chain.

In above embodiments, corresponding relationships between the various maintenance sites and usage deposits are stored in the database of the default server. The corresponding relationships may be stored in the database in a form of data table, and may be stored in other forms, which is not specifically limited herein. It should be appreciated that, the usage deposits corresponding to various maintenance sites may be same or different, and may be set flexibly by those skilled in the art according to practical situations.

As for refund of the deposit, the user may either send a request of refunding deposit to the server though the client after using the maintenance site once, or send a request of refunding deposit to the server after using multiple times. After receiving the request of refunding deposit, the server queries the deposit amount of the user and returns the deposit according to the payment path of the user.

S102: receiving check-in information during the target usage duration;

S103: providing usage permission of the target maintenance site to the client according to the check-in information.

In specific embodiment, after receiving the check-in information from the client during the target usage duration, the server controls the target maintenance site to open, and enables various maintenance equipments inside the target maintenance site be at a serviceable condition. It should be appreciated that, when the server does not receive the check-in information from the client during the target usage duration, the server may charge the user corresponding liquidated damage. The user may enjoy the next service only after the liquidated damage is paid, of course the user may deduct partial deposit according to preset rules, and the specific charging method is not specifically limited herein.

It should be noted that, the user may complete the check-in operation through the client identity identifier and/or the equipment identifier to be repaired, and obtain the usage permission of the maintenance site. That is to say, the check-in information and the reservation information both comprise the client identity identifier and/or the equipment identifier to be repaired, and the server will provide the usage permission of the maintenance site to the user after determining the identifiers in the check-in information and the reservation information having conformity. Specifically, when the reservation information includes information of the reservation person, i.e., the client identity identifier, the user scans the identifier information such as a two-dimensional code of the target maintenance site through the client to perform the check-in operation, the client packages its identifier in the check-in information and sends it to the server, and the server compares whether the identifier within the check-in operation and the identifier within the reservation information are consistent, if consistent, controls the target maintenance site being provided, otherwise, sends an unscheduled prompt to the user through the client. When the reservation information includes the equipment to be repaired, the identity identifier of the equipment is captured by an image collector inside the target maintenance site, and the server compares whether said identity identifier and the identity identifier of the equipment to be repaired in the reservation information are consistent, and if consistent, controls the target maintenance site being provided, otherwise, sends a prompt that said equipment is not unscheduled to the user through the client. In some specific application scenarios, that the server controls the target maintenance site being open, may be controlling the access control of the maintenance site for the user to enter the maintenance site, or may be that the server sends the access password to the user's client, and the user uses the access password to open the access control and enter the maintenance site. It is not limited by the present disclosure herein.

The method for maintenance sites management provided by the embodiments of the present disclosure, obtains the reservation information of the users through the client, and the reservation information comprises at least the target maintenance site and the target usage duration. The users only need to complete the check-in operation on the client during the target usage duration, the target maintenance site can be used during the target usage duration. The maintenance sites do not need to be registered by a special person, which reduces the labor cost and improves the usage efficiency of the maintenance sites, further realizing the sharing of the maintenance sites.

An embodiment of the present disclosure discloses a method for maintenance sites management, and this embodiment further describes and optimizes the technical solution with respect to the above embodiment. Specifically:

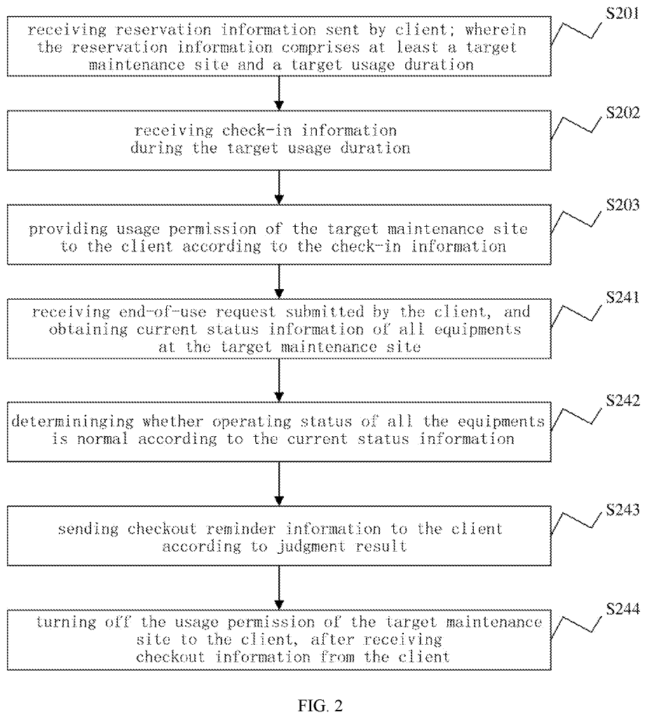

referring to FIG. 2, a flow chart of another method for maintenance sites management provided by the present embodiment of the disclosure, shown as FIG. 2, comprises;

S201: receiving reservation information sent by client; wherein the reservation information comprises at least a target maintenance site and a target usage duration;

S202: receiving check-in information during the target usage duration; S203: providing usage permission of the target maintenance site to the client according to the check-in information;

S241: receiving end-of-use request submitted by the client, and obtaining current status information of all equipments at the target maintenance site.

It should be appreciated that the maintenance sites may provide shared service for the users free of charge, or may require the users pay for the service. When the user needs payment, the server generates the maintenance service list and the charge list according to user's usage process after receiving the end-of-use request submitted by the client, initiates a payment transaction request based on the maintenance service list and the charge list to the client, and sends the checkout reminder information to the client after the client has completed the payment transaction. The corresponding relationships between the various maintenance sites and charge standards are stored in the database of the default server herein, in a similar way, the corresponding relationships may be stored in the database in a form of data table, and may be stored in other forms, and the usage costs corresponding to the various maintenance sites may be same or different, which is not specifically limited herein.

It should be appreciated that, the user may be prompted to time out at a preset time before the end of the target usage duration in order to improve the user experience, and the specific value of the preset time is not limited here. When the target usage duration ends, the usage permission of the target maintenance site is closed. Of course, as a preferred implementation, when the time that the user uses the scheduled maintenance site exceeds the reserved time period, the usage cost out of time may be counted into the above charge list.

S242: determining whether operating status of all the equipments are normal according to the current status information;

in specific implementation, the user sends the end-of use request to the server by the client after finishing using the target maintenance site, and the server collects the current status information of all the equipments inside the target maintenance site, and judges whether the operating status of the equipments is normal. For example, the operation state of the equipments may be monitored by running a monitor, the parameters values of the equipments may be collected by a voltage collector, a current collector, etc., and it is determined whether the parameters values is within a normal threshold range. For example again, it may be determined whether the user has followed the usage rules of the equipments by a camera or an infrared device, whether detachable parts of the equipments has returned to seats, whether movable parts of the equipments are at locations in their initial states (i.e., states before the user uses), and whether the overall cleaning degree of the equipments conforms to the standard, and the like. According to the above judgment results, an additional fee list is generated. That is to say, when the operating state is normal, the additional fee list is zero, and when the operating state is abnormal, the additional fee list is the compensation required to restore the damaged equipments to normal, and the user may check out only after having paid the additional cost.

As a preferred implementation, the storage method is the same with the above deposit payment transaction, the payment transaction of the usage costs and the additional costs may be uploaded to the block chain for storage, and the security of the deposit payment transaction of the usage costs and the additional costs is ensured taking advantage of the decentralized and non-tamperable features of the block chain.

S243: sending checkout reminder information to the client according to judgment result;

in specific implementation, after the user has finished the transaction of all costs through the client, the user is allowed to check out, i.e., the checkout reminder information is sent to the client, the user may check out through the client, and the client sends the checkout information to the server.

As a preferred implementation, the server may send the service list and the charge list to the client first, and the user is allowed to check out after confirming. The server initiates the payments transaction based on the above service list and charge list to the client after receiving the checkout information from the client, and the user may implement the next reservation operation only after having paid the usage costs.

S244: turning off the usage permission of the target maintenance site to the client, after receiving checkout information from the client.

In specific implementation, the server closes the usage permission of the target maintenance site for the client after receiving the checkout information from the client, i.e., the target maintenance site is at a non-available status and all the equipments inside the target maintenance site are at non-available status, and the user has no access to turn on all the above equipments.

The following introduces implementations when the maintenance sites management, provided by the above embodiments, is applied to vehicle maintenance. Specifically:

if the user's vehicle tire is broken down, the tire fault and the current location can be sent to the server as a reservation request through the mobile phone application, the server screens the vehicle maintenance sites where the tire equipments are at available status, and the available service periods of the maintenance sites meeting requirement are sent to the mobile terminal, further the user selects the maintenance site and the usage period to submit. The server initiates a payment transaction to the application according to the usage deposit corresponding to the maintenance site. After completing the payment transaction, the user can complete the check-in operation by scanning the QR code of the maintenance site through the mobile phone during the selected usage period, and the user can use all equipments inside the maintenance site during the usage period. After the usage is completed, the checkout operation is performed in the application, the server generates the maintenance service list and the charge list, and generates the additional charge list sent to the application together with the above service list and the charge list, according to whether the operation status of various maintenance equipments inside the maintenance site is normal. The user can only make a reservation for the next maintenance site after completing all the costs payment operations. The user may apply for refund deposit after using the maintenance site once and finishing payment transaction, or apply for refund deposit after multiple usages, and then obtain the deposit.

The following introduces implementations when the maintenance sites management, provided by the above embodiments, is applied to electrical equipments maintenance. Specifically:

if the user's electrical equipment is broken down, the current location can be sent to the server as a reservation information through the mobile phone application, the server sends the electrical equipments maintenance sites at available status currently to the application of the mobile terminal according to the distances, from near to far, from the current location, further the user selects the maintenance site and the usage period to submit. The server initiates a payment transaction to the application according to the usage deposit corresponding to the maintenance site. After completing the payment transaction, the user may complete the check-in operation by scanning the QR code of the broken electrical equipment by the scanner in the maintenance site during the selected usage period, and may use all equipments inside the maintenance site during the usage period. After the usage is completed, the checkout operation is performed in the application, the server generates the maintenance service list and the charge list, and generates the additional charge list sent to the application together according to the current status of all equipments. The user can only make a reservation for the next maintenance site after completing all the payment operations. The user may apply for refund deposit after using the maintenance site once and finishing payment transaction, or apply for refund deposit after multiple usages, and then obtain the deposit.

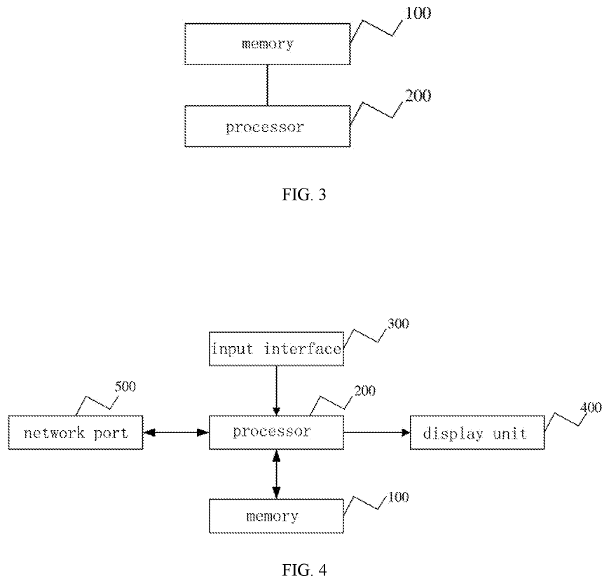

The present disclosure also provides a server for maintenance sites management. Referring to FIG. 3, a structural schematic view of a server for maintenance sites management disclosed by an embodiment of the present disclosure, shown as FIG. 3, comprises:
a memory 100 storing executable computer programs;
a processor 200 coupled with the memory;
specifically, the memory 100 comprises a nonvolatile storage medium, an internal memory.

The nonvolatile storage medium is stored with operation system and computer readable instructions, the internal memory provides environment for running of the operation system and the computer readable instructions in the nonvolatile storage medium. The processor 200 provides computing and controlling capacities for the maintenance site management server, when executing the computer programs stored in the memory 100 the processor may implement steps of: receiving reservation information sent by client; wherein the reservation information comprises at least a target maintenance site and a target usage duration; receiving check-in information during the target usage duration; providing usage permission of the target maintenance site to the client according to the check-in information.

The server for maintenance sites management provided by the embodiment of the present disclosure, obtains the reservation information of the users through the client, and the reservation information comprises at least the target maintenance site and the target usage duration. The users only need to complete the check-in operation on the client during the target usage duration, the target maintenance site can be used during the target usage duration. The maintenance sites do not need to be registered by a special person, which reduces the labor cost and improves the usage efficiency of the maintenance sites, further realizing the sharing of the maintenance sites.

Preferably, when executing the computer programs stored in the memory 100, the processor 200 may implements the following step of: sending information on at least one maintenance site to the client according to the reservation request, such that a user confirms the reservation information according to the information on at least one maintenance site.

Preferably, when executing the computer programs stored in the memory 100, the processor 200 may implement the following steps of: determining usage deposit of the target maintenance site according to the reservation information; initiating a payment transaction request of the usage deposit to the client, to enable the client to complete a deposit payment transaction; assigning a reservation usage qualification of the target maintenance site to the client after the client completes the deposit payment transaction.

Preferably, when executing the computer programs stored in the memory 100, the processor 200 may implement the following steps of: determining whether the client identity identifier in the check-in information is consistent with that in the reservation information, and/or determining whether the equipment identifier in the check-in information is consistent with the equipment identifier for maintenance in the reservation information; if consistent, providing usage permission of the target maintenance site to the client.

Preferably, when executing the computer programs stored in the memory 100, the processor 200 may implement the following steps of: receiving end-of-use request submitted by the client, and obtaining current status information of all equipments at the target maintenance site; determining whether operating status of all the equipments are normal according to the current status information; sending a checkout reminder information to the client according to judgment result; turning off the usage permission of the target maintenance site to the client after receiving a checkout information from the client.

Preferably, when executing the computer programs stored in the memory 100, the processor 200 may implement the following steps of: generating a maintenance service list and a charge list according to user's usage process; generating an additional fee list based on the judgment result; initiating a payment transaction request, based on the service list, the charge list and the additional fee list, to the client, such that the client completes the payment transaction; sending the checkout reminder information to the client, after the client has completed the payment transaction.

On basis of the above embodiments, the server for maintenance sites management, as a preferred implementation referring to FIG. 4, further comprises:
an input interface 300, connected with the processor 200 for acquiring externally imported computer programs, parameters and instructions which are then stored in the memory 100 through the control of the processor 200. The input interface 300 may be connected with an input device to receive the parameters or instructions manually input. The input device may be a touch layer covered on the display screen, and may be a button, trackball or touchpad arranged on the terminal housing, and may be a keyboard, touchpad or mouse or the like. Specifically, in the present embodiment, the sites information, of various maintenance sites or the like, is input through the input interface 300;
a display unit 400, connected with the processor 200 for displaying data sent by the processor 200. The display unit 400 may be a display screen on a PC, a crystal display screen or an e-ink display screen or the like. Specifically, in the present embodiment, the display 400 may display the current status information of various equipments in the maintenance site, the reservation information of users and the consumption information of various clients or the like;
a network port 500, connected with the processor 200 for communication connection with external various terminal equipments. The communication technology used in the communication connection may be wired communication technology or wireless communication technology, such as mobile high-definition link technology (MHL), universal serial bus (USB), high-definition multimedia interface (HDMI), wireless fidelity technology (WiFi), bluetooth communication technology, low-power bluetooth communication technology, communication technologies based on IEEE802.11s, etc. Specifically, in the present embodiment, the network port 500 may be used to import the enclosures, such as the corresponding relationships among the various maintenance sites, the charge standards and the usage deposits etc., to the processor 200.

The present disclosure further provides a computer readable medium storage, and the medium storage may comprises: various mediums able to store program codes such as a USB flash disk, a removable hard disk, a read-only memory (Read-Only Memory, ROM), a random access memory (Random Access Memory, RAM), a magnetic disk, or an optical disk etc. The storage medium is stored with computer programs, and when executed by the processor, the computer programs implement the following steps of: receiving reservation information sent by client; wherein the reservation information comprises at least a target maintenance site and a target usage duration; receiving check-in information during the target usage duration; providing usage permission of the target maintenance site to the client according to the check-in information.

The embodiment of the present disclosure obtains the reservation information of the users through the client, and the reservation information comprises at least the target maintenance site and the target usage duration. The users only need to complete the check-in operation on the client during the target usage duration, the target maintenance site can be used during the target usage duration. The maintenance sites do not need to be registered by a special person, which reduces the labor cost and improves the usage efficiency of the maintenance sites, further realizing the sharing of the maintenance sites.

Preferably, when executed by the processor, the computer subprograms stored in the computer readable storage medium may specifically implement the following steps of: sending information on at least one maintenance site to the client according to the reservation request, such that a user confirms the reservation information according to the information on at least one maintenance site.

Preferably, when executed by the processor, the computer subprograms stored in the computer readable storage medium may specifically implement the following steps of: determining usage deposit of the target maintenance site according to the reservation information; initiating a payment transaction request of the usage deposit to the client, to enable the client to complete a deposit payment transaction; assigning a reservation usage qualification of the target maintenance site to the client after the client completes the deposit payment transaction.

Preferably, when executed by the processor, the computer subprograms stored in the computer readable storage medium may specifically implement the following steps of: determining whether the client identity identifier in the check-in information is consistent with that in the reservation information, and/or determining whether the equipment identifier in the check-in information is consistent with the equipment identifier for maintenance in the reservation information; if consistent, providing usage permission of the target maintenance site to the client.

Preferably, when executed by the processor, the computer subprograms stored in the computer readable storage medium may specifically implement the following steps of: receiving end-of-use request submitted by the client, and obtaining current status information of all equipments at the target maintenance site; determining whether operating status of all the equipments are normal according to the current status information; sending a checkout reminder information to the client according to judgment result; turning off the usage permission of the target maintenance site to the client after receiving a checkout information from the client.

Preferably, when executed by the processor, the computer subprograms stored in the computer readable storage medium may specifically implement the following steps of: generating a maintenance service list and a charge list according to user's usage process; generating an additional fee list based on the judgment result; initiating a payment transaction request, based on the service list, the charge list and the additional fee list, to the client, such that the client completes the payment transaction; sending the checkout reminder information to the client, after the client has completed the payment transaction.

The various embodiments in the present description are described in a progressive manner, each embodiment focuses on differences from other embodiments, and the same or similar parts among the various embodiments may be referred to each other.

The above description of the disclosed embodiments enables those skilled in the art to implement or use the disclosure. Various modifications to these embodiments are obvious to those skilled in the art, and the general principles defined herein may be implemented in other embodiments without departing from the spirit or scope of the disclosure. Therefore, the present disclosure is not limited to the embodiments shown herein, but the broadest scope consistent with the principles and novel features disclosed herein.

The various embodiments in the present description are described in a progressive manner, each embodiment focuses on differences from other embodiments, and the same or similar parts among the various embodiments may be referred to each other. As for the system disclosed in the embodiments, since it corresponds to the method disclosed in the embodiments, the description is relatively simple, and the relevant sections can refer to the description of method sections. It should be noted that those skilled in the art can make various improvements and modifications to the present disclosure without departing from the principles of the present disclosure, and these improvements and modifications are also within the scope of the claims of the present disclosure.

It should also be noted that in the present description, relational terms, such as first and second or the like, are used merely to distinguish one entity or operation from another entity or operation, and do not necessarily require or imply that there is any such actual relationship or order between these entities or operations. Furthermore, the term “comprise”, “include” or any other variants that are intended to encompass a non-exclusive inclusion, such that a process, method, article, or device that comprises a plurality of elements includes not only those elements, but also other elements not listed specifically, or elements that are inherent to such a process, method, article, or device. Without more restriction, an element that is defined by the phrase “comprising a . . . ” does not exclude the presence of additional equivalent elements in the process, method, article, or device that comprises said element.

1. A method for maintenance sites management, comprising:
receiving reservation information sent by client; wherein the reservation information comprises at least a target maintenance site and a target usage duration;
receiving check-in information during the target usage duration;
providing usage permission of the target maintenance site to the client according to the check-in information.

2. A method for maintenance sites management of claim 1, wherein, before the step of receiving reservation information sent by client, the method further comprises:
receiving reservation request submitted by the client;
sending information on at least one maintenance site to the client according to the reservation request, such that a user confirm the reservation information according to the information on at least one maintenance site.

3. A method for maintenance sites management of claim 1, wherein, after the step of receiving reservation information sent by client, the method further comprises:
determining usage deposit of the target maintenance site according to the reservation information;
initiating a payment transaction request of the usage deposit to the client, to enable the client to complete a deposit payment transaction;
assigning a reservation usage qualification of the target maintenance site to the client, after the client completes the deposit payment transaction.

4. A method for maintenance sites management of claim 1, wherein, the reservation information further comprises a client identity identifier or an equipment identifier to be repair;
the step of providing usage permission of the target maintenance site to the client according to the check-in information, specifically comprises:
determining whether the client identity identifier in the check-in information is consistent with the client identity identifier in the reservation information, and/or determining whether the equipment identifier in the check-in information is consistent with the equipment identifier for maintenance in the reservation information;
if consistent, providing usage permission of the target maintenance site to the client.

5. A method for maintenance sites management of claim 1, wherein, the method further comprises:
receiving end-of-use request submitted by the client, and obtaining current status information of all equipments at the target maintenance site;
determining whether the operating status of all the equipments are normal according to the current status information;
sending a checkout reminder information to the client according to judgment result;
turning off the usage permission of the target maintenance site to the client, after receiving a checkout information from the client.

6. A method for maintenance sites management of claim 5, wherein, before the step of sending a checkout reminder information to the client, the method further comprises:
generating a maintenance service list and a charge list according to user's usage process;
generating an additional fee list based on the judgment result;
initiating a payment transaction request, based on the service list, the charge list and the additional fee list, to the client, such that the client completes the payment transaction;
sending the checkout reminder information to the client, after the client has completed the payment transaction.

7. A server for maintenance sites management, comprising:
a memory storing executable computer programs;
a processor coupled with the memory;
when used for executing the computer programs the processor implements steps of: receiving reservation information sent by client; wherein the reservation information comprises at least a target maintenance site and a target usage duration; receiving check-in information during the target usage duration; providing usage permission of the target maintenance site to the client according to the check-in information.

8. A server for maintenance sites management of claim 7, wherein, when executing the computer programs stored in the memory the processor implements steps of: receiving a reservation request submitted by the client; sending information on at least one maintenance site to the client according to the reservation request such that a user confirms the reservation information according to the information on the at least one maintenance site.

9. A server for maintenance sites management of claim 7, wherein, when executing the computer programs stored in the memory the processor implements steps of: determining usage deposit of the target maintenance site according to the reservation information; initiating a payment transaction request of the usage deposit to the client, to enable the client to complete a deposit payment transaction; assigning a reservation usage qualification of the target maintenance site to the client after the client completes the deposit payment transaction.

10. A server for maintenance sites management of claim 7, wherein, when executing the computer programs stored in the memory the processor implements steps of: determining whether the client identity identifier in the check-in information is consistent with that in the reservation information, and/or determining whether the equipment identifier in the check-in information is consistent with the equipment identifier for maintenance in the reservation information; if consistent, providing usage permission of the target maintenance site to the client.

11. A server for maintenance sites management of claim 7, wherein, when executing the computer programs stored in the memory the processor implements steps of: receiving end-of-use request submitted by the client, and obtaining current status information of all equipments at the target maintenance site; determining whether the operating status of all the equipments is normal according to the current status information; sending a checkout reminder information to the client according to judgment result; turning off the usage permission of the target maintenance site to the client after receiving a checkout information from the client.

12. A server for maintenance sites management of claim 11, wherein, when executing the computer programs stored in the memory the processor implements steps of: generating a maintenance service list and a charge list according to user's usage process; generating an additional fee list based on the judgment result; initiating a payment transaction request, based on the service list, the charge list and the additional fee list, to the client, such that the client completes the payment transaction; sending the checkout reminder information to the client after the client has completed the payment transaction.

13. A computer readable storage medium, wherein the computer readable storage medium is stored with computer programs, wherein when executed by a processor the computer programs are used for implementing the steps of:
receiving reservation information sent by client wherein the reservation information comprises at least a target maintenance site and a target usage duration;
receiving check-in information during the target usage duration;
providing usage permission of the target maintenance site to the client according to the check-in information.

14. A computer readable storage medium of claim 13, wherein when executed by a processor the computer programs are further used for implementing the steps of:
receiving reservation request submitted by the client;
sending information on at least one maintenance site to the client according to the reservation request, such that a user confirm the reservation information according to the information on at least one maintenance site.

15. A computer readable storage medium of claim 13, wherein when executed by a processor the computer programs are further used for implementing the steps of:
determining usage deposit of the target maintenance site according to the reservation information;
initiating a payment transaction request of the usage deposit to the client, to enable the client to complete a deposit payment transaction;
assigning a reservation usage qualification of the target maintenance site to the client, after the client completes the deposit payment transaction.

16. A computer readable storage medium of claim 13, wherein, the reservation information further comprises a client identity identifier or an equipment identifier to be repair;
the step of providing usage permission of the target maintenance site to the client according to the check-in information, specifically comprises:
determining whether the client identity identifier in the check-in information is consistent with the client identity identifier in the reservation information, and/or determining whether the equipment identifier in the check-in information is consistent with the equipment identifier for maintenance in the reservation information;
if consistent, providing usage permission of the target maintenance site to the client.

17. A computer readable storage medium of claim 13, wherein when executed by a processor the computer programs are further used for implementing the steps of:
receiving end-of-use request submitted by the client, and obtaining current status information of all equipments at the target maintenance site;
determining whether the operating status of all the equipments are normal according to the current status information;
sending a checkout reminder information to the client according to judgment result;
turning off the usage permission of the target maintenance site to the client, after receiving a checkout information from the client.

18. A computer readable storage medium of claim 17, wherein when executed by a processor the computer programs are further used for implementing the steps of:
generating a maintenance service list and a charge list according to user's usage process;
generating an additional fee list based on the judgment result;
initiating a payment transaction request, based on the service list, the charge list and the additional fee list, to the client, such that the client completes the payment transaction;
sending the checkout reminder information to the client, after the client has completed the payment transaction.
